(19) United States
(12) Patent Application Publication
(10) Pub. No.: US 2007/0285304 A1
(43) Pub. Date: Dec. 13, 2007

(54) TARGET ORBIT MODIFICATION VIA GAS-BLAST

(76) Inventor: GUY COOPER, VENTURA, CA (US)

Correspondence Address: MICHAEL BLAINE BROOKS, P.C., P.O. BOX 1630, SIMI VALLEY, CA, 93062-1630, US

(21) Appl. No.: 11/686,685

(22) Filed: Mar. 15, 2007

Related U.S. Application Data
(60) Provisional application No. 60/783,658, filed on Mar. 16, 2006.

(51) Int. Cl. B64G 1/24; B64G 1/00; B64G 1/40; F02K 9/00; G01S 13/00

(52) U.S. Cl. 342/62; 244/158.1; 244/164; 244/171.1; 60/200.1

(57) ABSTRACT

The gas blast from a directed rocket motor transfers an impulse vector to a space target object thereby altering the target's orbit. Preceding the gas blast, a lower level of rocket exhaust may be directed to the target object for profile imaging that may include center of gravity determination using a pulse Doppler radar sighted along the exhaust stream. A deflector may be deployed to redirect a portion of the gas blast. In some cases, a special non-shrapnel nosecone warhead may be substituted for or used in conjunction with the rocket motor as a source of a gas blast.

### CROSS-REFERENCE TO RELATED APPLICATIONS

This application claims the benefit of provisional application No. 60/783,658, filed Mar. 16, 2006, the disclosure and appendices of which are hereby incorporated by reference herein, in their entirety, for all purposes.

### BACKGROUND

1. Technical Field

The invention, it its several embodiments, pertains to orbit debris relocation and the present field of endeavor more particularly pertains to methods, systems and apparatuses adapted to impart orbital changes to satellites, orbital debris, and other orbital targets via directed gas.

2. State of the Art

State of the art space debris clearing includes the use of explosive charges, or shaped energetics to impart an impulse on the intended field of space to change their velocities and orbits. The resulting explosion may have the debris shifted to a higher orbit or diverted into a decaying orbit resulting in incineration on atmospheric re-entry. State of the art space debris clearing includes an apparatus that mechanically impacts and adheres to the impact debris and includes an apparatus that mechanically grapples the debris and has the apparatus and grappled cargo incinerated upon atmospheric re-entry. Another state of the art space debris clearing apparatus imparts electromagnetic energy upon targeted debris until a level of disintegration of the debris is achieved.

### SUMMARY

The invention, in its several embodiments includes a system comprising a rocket motor adapted to produce directed exhaust gas particles; a targeting system adapted to determine a first aim point for the directed exhaust; and an attitude control system adapted to orient the rocket motor in response to the determined first aim point. In other embodiments of the invention the system may further comprise a thrust-reversing element adapted to deflect a portion of the directed exhaust, which may in some embodiments comprise a fuselage, the fuselage housing at least a portion of the rocket motor wherein the thrust-reversing element is a steel foil attached to the fuselage via three or more suspension lines. In other embodiments of the invention the system may comprise a fuselage wherein the targeting system includes a radar system proximate to the fuselage, which may in some embodiments comprise a fuselage wherein the propellant of the rocket motor is seeded to exhaust radar-reflective particles. In other embodiments of the invention the system may further comprise a fuselage wherein the targeting system is adapted to process radar returns from a plurality of gas particles proximate to the target space object and there from determine a second aim point. In other embodiments of the invention the system may also be a system comprising an exo-atmospheric vehicle adapted to produce a directed gas-blast via a frangible nosecone; and a targeting system adapted to determine an aim point for the directed gas-blast.

The invention, in its several embodiments also includes a method of imparting momentum to a target space object comprising an exhaust gas generator proximate to the target space object wherein the exhaust gas generator is adapted to expel generated gas according to a trajectory, and directing a first blast of expelled generated gas wherein at least a portion of the trajectory of the first blast of expelled generated gas impinges on the target space object. Other embodiments of the invention may include a method of imparting momentum to a target space object providing an exhaust gas generator proximate to the target space object wherein the exhaust gas generator is adapted to expel generated gas according to a trajectory, and directing a first blast of expelled generated gas wherein at least a portion of the trajectory of the first blast of expelled generated gas impinges on the target space object which may in some embodiments comprise determining an aim point for a second blast of expelled generated gas based on radar returns from a plurality of expelled gas particles proximate to the target space object and directing a second blast of expelled generated gas wherein at least a portion of the trajectory of the second blast of expelled generated gas impinges on the target space object. In other embodiments of the invention, the method may further comprise deflecting a portion of the expelled generated gas via a thrust reversing element. In still other embodiments of the invention, the method may further comprise deploying a thrust reversing element comprising steel foil into the trajectory of the first blast of expelled generated gas. In other embodiments of the invention, the method may include the expelled generated gas of at least the first blast to be comprised of radar-reflective particles.

### BRIEF DESCRIPTION OF THE DRAWINGS

For a more complete understanding of the present invention and for further features and advantages, reference is now made to the following description taken in conjunction with the accompanying drawings, in which:

FIG. 1 illustrates an exemplary depiction of an example of a gas blast delivering an impulse to a satellite whose orbit is to be elevated;

FIG. 2 illustrates and exemplary interceptor missile's direct ascent encounter trajectory which aims a rocket engine exhaust gas-blast at target, according to an embodiment for the invention;

FIG. 3 illustrates cooling of various sized carbon exhaust particles with distance for a 6000 ft/sec rocket exhaust velocity, according to an embodiment for the invention;

FIG. 4 is an exemplary interceptor missile design to use aimed, space-chilled exhaust of its own propulsion rocket motor as the gas-blast generator, according to an embodiment for the invention;

FIG. 5A illustrates a target satellite silhouette imaged using impingement of radar-scattering particles in rocket exhaust, according to an embodiment for the invention;

FIG. 5B shows a target satellite profile superimposed on a radar resolution cell grid, according to an embodiment for the invention;

FIG. 6A shows an example of radar cell imagery, according to an embodiment for the invention;

FIG. 6B shows an example of radar cell imagery, according to an embodiment for the invention;

FIG. 7 illustrates that the Doppler radar determines target approach & rotation;

FIG. 8 shows an example of an interceptor missile encountering a satellite during a formation flight co-orbit trajectory, according to an embodiment for the invention;

FIG. 9 shows an example of an interceptor missile delivering orbit-changing impulse to a satellite to lift its orbit, according to an embodiment for the invention;

FIG. 10 is an example of an interceptor missile blowing debris out of orbit, according to an embodiment for the invention;

FIG. 11A illustrates variable definitions, according to an embodiment for the invention;

FIG. 11B illustrates dynamical relationships, according to an embodiment for the invention;

FIG. 11C illustrates time-position relation variables between interceptor missile and target, according to an embodiment for the invention;

FIG. 11D illustrates a cone of exhaust particle trajectories, according to an embodiment for the invention;

FIG. 12 illustrates the displacement effects on target and rocket with exhaust plumes of various diverging angles, according to an embodiment for the invention;

FIG. 13 shows an exemplary “thrust reverser, according to an embodiment for the invention;

FIG. 14A illustrates design parameters of the thrust reverser, according to an embodiment for the invention;

FIG. 14B shows an exemplary thrust reverser foil element, according to an embodiment for the invention;

FIG. 15A illustrates a vacuum chamber ballistic pendulum to evaluate designs for gas-blast impulse transfer to a target, according to an embodiment for the invention;

FIG. 15B is an example of dynamical relationships, according to an embodiment for the invention;

FIG. 16 illustrates simulating a gas-blast source using a capacitor-driven submerged spark gap, according to an embodiment for the invention;

FIG. 17 illustrates finite element analysis of nosecone gores, according to an embodiment for the invention;

FIG. 18 shows and exemplary nosecone, according to an embodiment for the invention;

FIG. 19 shows an exemplary gore, according to an embodiment for the invention; and

FIG. 20 shows an exemplary gore blast dynamic, according to an embodiment for the invention.

### DETAILED DESCRIPTION

The invention in its several embodiments includes methods and apparatuses adapted to impart, via exhaust gas particles, one or more directed impulses on targeted space debris and thereby remove some or all of the targeted debris from the orbital trajectories they held prior to the application of the directed impulses. The invention in its several embodiments includes an apparatus, system and method of modifying the space orbit of an object, for example, an object in low earth orbit (LEO), by use of a gas-blast to transfer an impulse to the target object in question which may raise its orbit. Embodiments of the present invention may include an interceptor missile where a rocket motor of the vehicle issues an exhaust, e.g., a gas-blast, which may be directed toward the target object.

An exemplary apparatus may be embodied as missiles having an on-board Doppler radar with processing that can image and discern the target object sufficiently to determine its relative approach velocity, its rotation or relative rotational orientation, and for example, the determination of its relative range, which may also determine its approximate size. In some embodiments, a target assessment method may be applied where a missile rocket motor is directed to apply a small test blast to the target and observing and processing by the radar system to determine the resulting changes in vehicle rotation to confirm or refine the estimate of the target's effective gas-dynamic center and radar processing, which may determine the resulting translation to confirm or refine the estimate of the target object mass properties. Information such as the target object's gas-dynamic center and mass properties may then drive determination of the requisite magnitude and aiming of the main gas-blast.

The missile embodiments of the present invention include a rocket engine that may be used to propel the missile, and, when directed to intercept an approaching target satellite, the rocket engine may be used in to impart an impulse vector, for example, by directing an expansion and radiation cooled exhaust gas, such as a free-molecule wind, toward the target object to deliver an impulse vector. Due to the controllable characteristics of liquid and hybrid rocket motors, this impulse vector may be delivered in an extremely attenuated form so that no damage occurs to the space structure; or, it may be delivered with extreme intensity where, for example, resulting damage and/or heating of the target item is of no consequence. Another exemplary source of the gas-blast impulse may be a warhead that may be placed within a frangible nosecone where portions of the nosecone may direct the gas volume toward the target without allowing shrapnel to impact the target.

The missile embodiments may be included in an interception system where the determination of the silhouette of a target satellite, or other space vehicle, for example and for purposes of gas blast aim point, may be done by observing the pattern of departing microwave scattering particles seeded into the rocket exhaust blast using a pulse Doppler radar. The return Doppler pattern in the radar resolution cells enables a targeting computer, or guidance subsystem, to identify the silhouette of the target satellite. The guidance of the missile to achieve a precise intercept of its exhaust gas “slug” with the target may be achieved by determining the target's changed trajectory relative to the intercepting missile and rotation and orientation states using low power, high frequency pulse Doppler radar, which are typically implemented with miniature electronics.

In some embodiments of the missile, a thrust reversing element is deployed which redirects as much a 180 degrees the direction of part of the missile exhaust while allowing a portion of the exhaust to pass through the thrust reversing elements unhindered and thereby direct the exhaust onto a target object while reducing the departure velocity between the missile and the target object. In some embodiments the thrust-reversing elements which may consist of a central hole in the canopy permit the central portion of the rocket exhaust to go through and impinge on the target object, for example, a satellite or some space junk in order to transfer an orbit-changing impulse to it. Moreover, in all embodiments the thrust-reversing element comprises steel foil that radiates heat fast enough to keep the steel foil sufficiently below its melting temperature. The steel foil canopy embodiments of the thrust-reversing element may be positioned and/or held in place relative to the missile via steel cable risers and/or suspension lines.

Some embodiments of the missile may include a frangible nosecone that may split into longitudinal tapered gores that bend, but do not break, under an explosive gas blast, and may be retained at the base of the nosecone. The selected gore shape and material, in combination with the explosive formulation, work to concentrate and focus the blast gases in part by the inertial confinement provided by the gore strips. An operational use of the gas-blast impulse technique typically includes an intercept trajectory that, when followed, causes the missile to close relative range with the target object, or objects, and may do so at an angle that delivers, at encounter, the desired impulse vector to the target object to achieve the desired final momentum vector. The post-encounter trajectory of the remaining missile structure may de-orbit the missile, or take it away from the final orbit of the target object. Operational use of a gas blast warhead typically includes end-point aiming in order to deliver the gas-blast accurately at the target object, typically the target object's centroid as understood by the guidance algorithm of a missile guidance computer, for maximum impulse transfer. The actual gas slug-target intercept computations driving the resulting trajectory may include a computed lead angle to account for range, relative closing velocities, and blast-gas flight speed. The nature of the warhead blast and lateral spread are typically known and may be predicted depending on missile orientation relative to the target and the time-to-go until intercept. Prior to actual intercept, the operational use of the warhead typically includes computations of estimates of range from the target object at which the detonation occurs, and before that, using a computerized fusing function. This standoff range, together with the relative closing velocity, establishes the time-to-go post detonation that governs the lateral spread of the blast gases and the free molecule dynamic pressure applied to the target mass.

The gas-blast delivery may be based on processing that determines a standoff distance or range and thrust orientation or aim. The determination typically depends upon the desired direction for the delivered impulse vector. The impulse vector may be applied to raise the orbit of the target object, or to cause the object to re-enter the earth's atmosphere and burn up or, by incorporating additional orbital dynamic processing, cause the target object to splash down on the Earth's surface where and when desired. The gas-blast method of impulse delivery may be used to rotate, or de-spin a space capsule to change the orientation of solar energy panels or telemetry antennae; or to permit docking for a space rescue or for emergency maintenance. While the gas blast can be extremely gentle in terms of gas particle flux density and/or velocity in order, for example, to avoid damage to a delicate space structure, it may be applied in a much more vigorous form in terms of gas particle flux density and/or velocity to blow dangerous debris, e.g., space junk, out of the orbital corridor occupied by, for instance, the International Space Station or a planned manned mission.

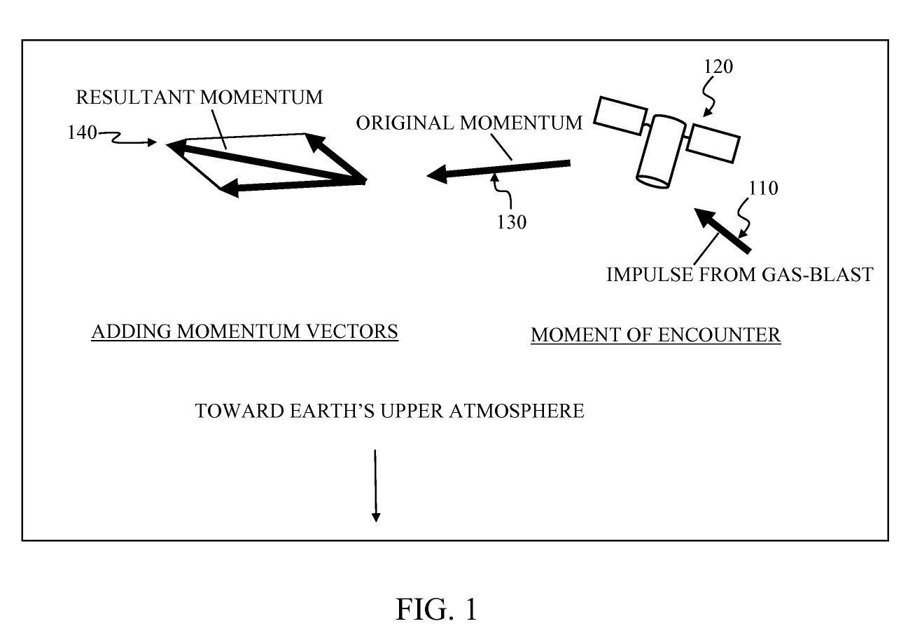

FIG. 1 shows an example of a gas blast delivering an impulse 110 to a satellite 120 having an original momentum vector 130 whose orbit is to be elevated via resultant momentum 140 to prevent, for instance, unwanted reentry into the Earth's atmosphere, or to move it out of an inadequately low orbit resulting from a partial launch failure. The impulse 110 from the gas blast is the incremental momentum acquired by the satellite resulting from its drag in the free-molecule flow of the gas-blast. Those molecules not striking the satellite play no role in transferring momentum. The change in satellite resultant momentum vector 140 is shown exaggerated in this example; a single-encounter momentum change would be much less in order to avoid damaging a satellite. The example shown here is the rescue of an expensive satellite in orbital decay that without momentum change would eventually burn up in the atmosphere.

Prior to directing a gas blast at a targeted space object, it may be necessary to image the target to determine its aerodynamic center, that is, the effective center of pressure in the face of a moving gas particle volume. Imaging, in this example, may include the application of Doppler radar and processing to map departing reflective particles in the exhaust blast as these particles may be moving with the moving gas volume. In some embodiments, there may be a special seeding of the exhaust gas with particularly radar-reflective particles if greater radar reflectivity is needed for the determination of the space target object's aerodynamic center of pressure. In this exemplary application, where the gas particles impinge the space target object, they stagnate, or stop moving due, for example, to momentum transfer. The velocity contour of this particle stagnation provides a reflected outline or profile of the space target object, thereby enabling a gas-dynamic center determination.

A number of encounter trajectories may be designed for the closure of the interceptor missile with the target to deliver its impulse gas-blast. In a direct ascent trajectory, the interceptor missile is guided and propelled by one or more rocket engine motors requiring at least enough energy to directly ascend to the altitude of the target orbit where impulse is transferred according to the teachings herein during the passing encounter, for example. This trajectory may be applied in cases where it is desirable to de-orbit space junk or a dead satellite or in cases where much of the target satellite orbital characteristics are well known a priori and accordingly precise guidance and relative orienting of the interceptor missile is possible.

Another example of the several trajectories is a co-orbital trajectory where the interceptor, e.g., the missile, may have or require more energy over the direct ascent trajectory described above and where the interceptor is placed in an orbit closely paralleling that of the target, e.g., the orbital debris. This paralleling of orbits allows time for the application of an initial gas-blast, the results of which may be observed by the interceptor missile, for example, via infrared or radar backscatter imaging and there from characterize the dynamical response of the target to the initial gas-blast of the target. Such a characterizing gas-blast may be applied, for example, for missions where precise gas-blast aiming may be required in order to alter the orbit or change the spin axis of a delicate satellite or manned capsule, that is objects or vehicle cargos having structures exhibiting low structural tolerance to high linear or rotation accelerations.

An exemplary thrust-reversing embodiment has the outer portions of the rocket exhaust, for example, the portion of particles that would otherwise go past the target and be wasted, blocked in their nominal trajectories and may be re-directed more than 90 degrees, for example 180 degrees, to provide a counter-thrust. This partial redirection of the exhaust plume results in the interceptor missile experiencing less net departure acceleration than a similarly firing interceptor without a thrust reverser, accordingly the missile of the exemplary thrust-reversing embodiment remains in proximity to the target longer, thereby delivering more impulse to the target.

Beyond a short distance from the nozzle, a chemical combustion rocket exhaust cools dramatically when flowing into the vacuum of space. While it is space-chilled, losing thermal energy by radiation; the momentum of the gas-blast remains the same. The delivery of this gas-blast can be planned to thrust the intercept missile away from the target object and its orbit, and into its own return-to-earth trajectory; thus leaving no orbital debris or space junk of its own. A liquid or hybrid fueled rocket may be fired a number of times for controlled durations. The duration of burn at a constant thrust generates the impulse that may be delivered to the target upon which the exhaust gas impinges.

Another embodiment has the gas-blast generated by a warhead, e.g., a non-shrapnel warhead that may be part of a system where an energetic element is place within a frangible nosecone, for example a nosecone that splits, due to the pressure of the detonated energetic, into gore sections that remain captive to the missile fuselage, splaying out in the process.

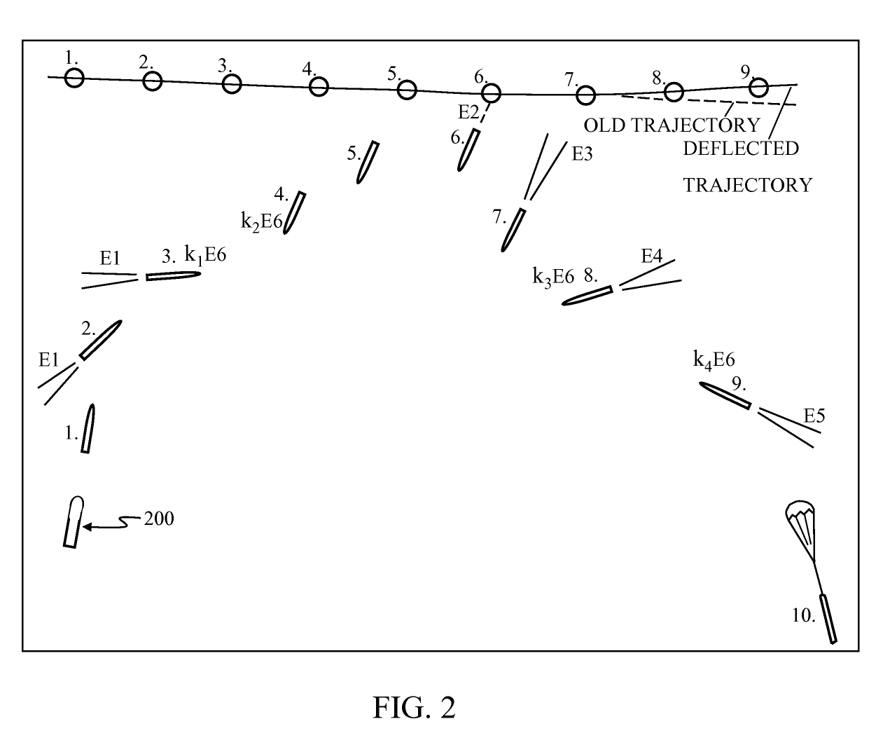

Some missile embodiments may have a hybrid or liquid propulsion system that may be available as a propulsion stage of an Earth-launched vehicle. Hybrid or liquid propulsion systems may be equipped with mechanisms, such as valves that may be turned on and off a number of times as well as throttled, via an actuated pintle for example. As shown by example in FIG. 2, the first use of a propellant takes the vehicle into position relative to the target object. The missile is then rotated 180 degrees from its nominal orientation, until the rocket nozzle is directed at the proper target intercept point where the exhaust particle cloud will intercept the target and transfer an impulse to it due to free-molecule gas loads. Selection of the desired intercept point is determined by well-known missile target tracking and course-correction laws, which are implemented in both the ground control and the missile itself. In FIG. 2 the missile 200 is shown to fire a second burst to generate a target image used in the determination of its gas dynamic center and mass centroid.

Aiming correction is made, as shown in FIG. 2, and a third major rocket firing delivers the desired impulse to the target.

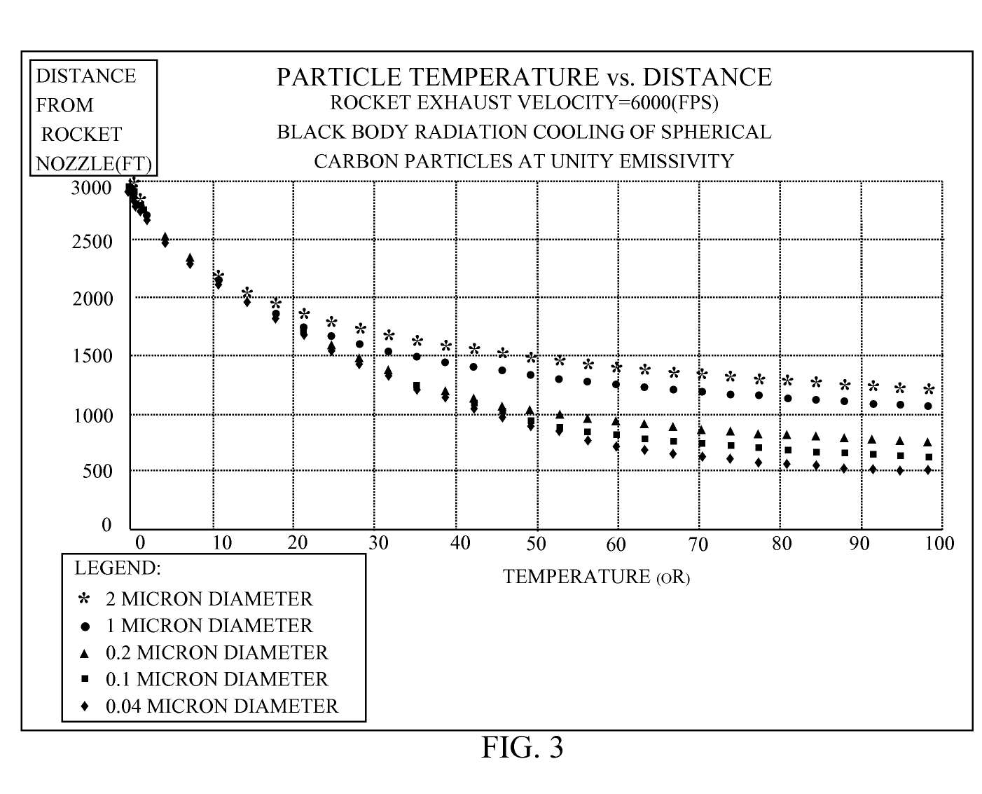

The sequence of energy expenditures (E1-E5), in FIG. 2 is shown opposite the corresponding target intercept missile positions to represent progressive consumption of missile propellant, or energy budget. The values k1, k2, k3, k4 times E6 are successive fractional uses of the missile rotation energy budget, E6, where small lateral rockets are used, as shown in FIG. 3 below. Exemplary mission steps are as follows:
1. Detach from last stage and coast;
2. Full thrust to establish intercept trajectory with target satellite, E1;
3. Rotate while continuing full thrust, k₁E6 and E1;
4. Rotate 180 degrees to aim rocket exhaust at calculated target blast gas intercept point, k₂E6;
5. Coast to range for interrogation gas blast, E2;
6. Fire rocket to generate interrogation gas blast, E2
7. Calculate and perform fine tune aim and main gas blast, E3;
8. Rotate to de-orbit attitude and fire de-orbit thrust, blast, k₃E6 and E4;
9. Fire atmospheric entry deceleration thrust while rotating to vertical descent, k₄E6 and E5; and
10. Deploy drogue and main chute in lower atmosphere.

The encounter in FIG. 2 is more appropriate for co-orbital flight. In a direct ascent encounter, the satellite typically would be moving considerably faster than the missile; two interceptor missiles would be required. Precise pre-calculated aim-points may be required for both the determination of the target's gas-dynamic and mass properties by the first interceptor missile. The second missile would deliver the primary gas-blast impulse.

Table I (Appendix) lists the impulse pound-seconds for each of the exemplary major rocket firings shown in FIG. 2. In this example, one of ordinary skill in the art recognizes reasonable energy expenditures, as percentages of the total propellant budget, being presumed for a typical missile-target encounter scenario. For energy accounting purposes, a small amount of propellant, E6 in Table 1, is presumed, in this example, to be provided as a consumable for missile steering and rotation using lateral rockets.

From basic rocket engine theory in “Rocket Propulsion Elements” 2^{nd} Edition, by George P. Sutton, the following relationships are applied to generate the data of Table 1:

Thrust=Propellant Flow Rate×Specific Impulse

Burn Time=Percent Propellant Use×Total Burn Time

Impulse=Thrust×Burn Time

Missile Velocity Change=Impulse/Missile Mass (corrected during burn)

If determination of the target gas dynamic center is unimportant, that is, no despinning is required or the target is merely regarded as orbital debris to be de-orbited, then the small test blast against the target may be omitted and its energy applied in the main gas blast.

The issue of the gas blast heating, or otherwise damaging the target is best addressed by the following empirical formula (Eqn. 5-15 on p. 157 of “Rocket Propulsion Elements” 2^{nd} Edition, by George P. Sutton):
L=square root (F/f) (1) [Eq. 1]
where L is the length of the visible flame in feet, F is the thrust in pounds, and f is an empirical factor of 10 (when using ft-lb units). The above Eq. 1, applies for ordinary propellants at sea level conditions, but it suggests that exhaust particles cool rapidly due to radiation. A computer program was written using black body radiation cooling of carbon particles in a typical rocket exhaust stream. Free-molecule flow only is assumed. Results indicate that significant cooling (i.e., space-chilling) occurs within a short distance of the nozzle exit. FIG. 3, which plots the data used for Tables IIA and IIB, indicates that smaller carbon particles (e.g., 0.04 to 0.2 micron diameter) drop below 1000 degrees Fahrenheit at a distance from the nozzle of between 20 and 40 feet. This compares well with Eq. 1, which for a 4000 lb. thrust rocket motor (as used in Table I) indicates the limit of visible exhaust at 20 feet.

Potential gas-blast damage to the target object may be estimated by addressing the kinetic energy of the presumed gas particle, e.g., a carbon particle, and presuming the structural strength of the weakest material to be found on an exemplary target satellite. For example, a typical fiberglass component having a 3000-psi compressive failure strength was selected. Carbon particle impact cratering was sized by converting the kinetic energy of the carbon particle into cratering work, i.e., depth of crater x material failure strength. The resulting crater depth is very small. Blackbody radiation was presumed to carry away most combustion-caused residual heat of the particle. Reheating due to impact was determined by converting the total carbon particle's kinetic energy into heat of the carbon particle itself. These exemplary results indicate about a 720th of a degree Rankin rise (or 260 degrees Fahrenheit) in temperature, due to impact of the chosen carbon particle size.

FIG. 3 shows exemplary radiation cooling of various sized carbon particles with distance. The range of particles shown is typical of the soot found in rocket exhausts in “Rocket Exhaust Plume Phenomenology” by Frederick S. Simmons. FIG. 3 is developed using the same computer program used with Tables II A and II B(Appendix).

Using Eq. 1 for a 4000 lb. thrust rocket motor & a value of constant f=10, the visible plume length is approximately 20 ft. For a larger 20,000 lb. thrust rocket motor, the visible plume length would be approximately 45 ft. It is seen that based purely upon black body radiation cooling of carbon particles, very modest temperatures may be achieved a short distance from the rocket exhaust nozzle. All of these variables, i.e., plume cooling distance, target heating and/or impact damage, may be tested at sub-scale in a space chamber, as described below in Sub-Scale Testing.

Interceptor Missile

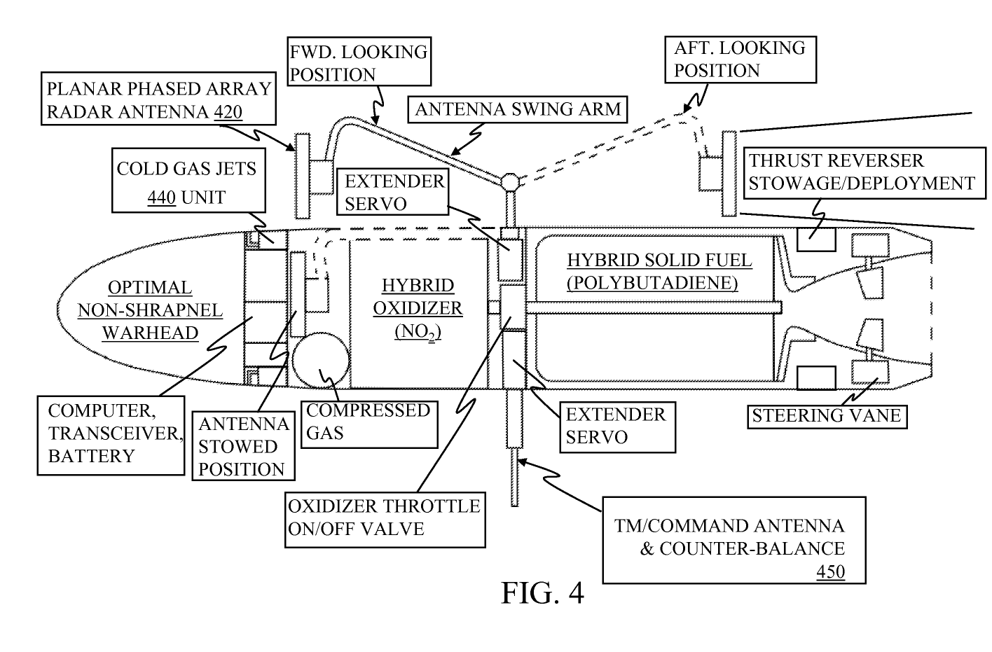

An exemplary embodiment of a missile for use as a direct rocket motor exhaust blast trajectory deflection device is shown in FIG. 4. FIG. 4 is a general exemplary design that may also accommodate the non-shrapnel warhead in its nosecone. The radar preferably includes arrays of RF antenna elements with scanning done electronically. The high frequency, e.g., low power Ka-band, radar allows for small antennas and microwave hardware. It is estimated that, once the boost phase has placed the missile in an intercept box to encounter the selected target satellite, approximately 10 watts of radar power are adequate because the intercept distances are relatively short.

Both the warhead blast directed for example via a frangible nosecone and the directed rocket exhaust are means of emitting a gas-blast from a missile in accordance with a reference aim point. For some of the rocket-generated gas-blast embodiments, a radar array 420 may first generate RF emission in the forward direction so that its radar returns may yield a relative target location and the returns may provide a basis for guiding the initial phase of the approach. As the missile nears the effective range of the exhaust thrust, the missile is rotated to a rearward approach to allow close-up identification of the target via the radar system and a determination of the silhouette of the target for purposes of selecting the gas dynamic aim point center. Attitude reorientation and control may be effected by hot, warm or cold gases and, in some embodiments, cold gas jets 440 may be pulsed or throttled to rotate the missile end-for-end, where the rocket motor is accordingly positioned to deliver the interrogation gas-blast to ascertain target properties, and the cold jet may also be applied in the fine aiming of the thrust plume, for example, according to the estimated center of pressure of the target or some other aim point prior to the main gas-blast delivery.

Conformal forward and aft looking antenna elements may be used for either telemetry or command and control, or both telemetry. An extended antenna 450 for telemetry and command reception may be formed and positioned to provide counterbalancing mass relative to the extended radar antenna that may be deployed on the opposite side of the vehicle. This counterbalancing keeps the CG on the thrust centerline to eliminate unwanted moments during rocket thrusting, or during the alternate non-shrapnel warhead discharge. The counterbalancing may be applied to address, what those of ordinary skill in the art understand to be, the off-diagonal terms of the vehicle's inertia tensor.

An exemplary embodiment may, for example, have typical specifications which include the following:

Weight: 4000 lbs.

Thrust: 4000 lbs.

Specific impulse(ISP): 200 to 250 sec.

Mass ratio (fuel weight/total weight): 0.8

Radar (ranging and target analysis): 10 w pulse Doppler

Typically, counter-balance maintains center of gravity (CG) on thrust center line regardless of antenna location and compressed gas (i.e., dry nitrogen) powers cold gas jets for vernier steering/rotation. Typically, the antenna array looks forward to locate and guide on target satellites and typically looks rearward to characterize target silhouette for blast-gas aiming purposes. Typically, hybrid fuel,(e.g., polybutadine) lateral surfaces are inhibited for end-burning only so thrust typically remains constant for all burns.

Radar Determination of Target Shape and Motion

Determination of the target shape or profile for a determination of an aim-point for the gas blast may be made via processing using the returns of a Doppler radar to observe the departure velocity pattern of radar-reflective particles that may be a seeded into, or are a natural part of, the rocket exhaust. These particles may be seeded into the exhaust gases by mixed them into the solid fuel grain of the rocket during manufacture. For example, particles having a high dielectric constant may be evenly distributed in a butadiene fuel at a very low density (e.g., less than a fraction of a percent of the weight of the fuel grain). Particles with a high dielectric constant may provide microwave scattering. The size and density of the particles may be selected to provide for scattering in the Ka microwave band thereby producing a discernable velocity signature for the pulse Doppler receiver. In addition, typical hybrid rocket exhaust particles may have sufficient dielectric constant to provide an adequate backscatter to the Ka band microwaves. As an alternative example, some metal, such as aluminum, may be dispersed in powder form in the fuel grain during manufacture. Accordingly as a result of combustion, aluminum oxide having a high dielectric constant would be exhausted.

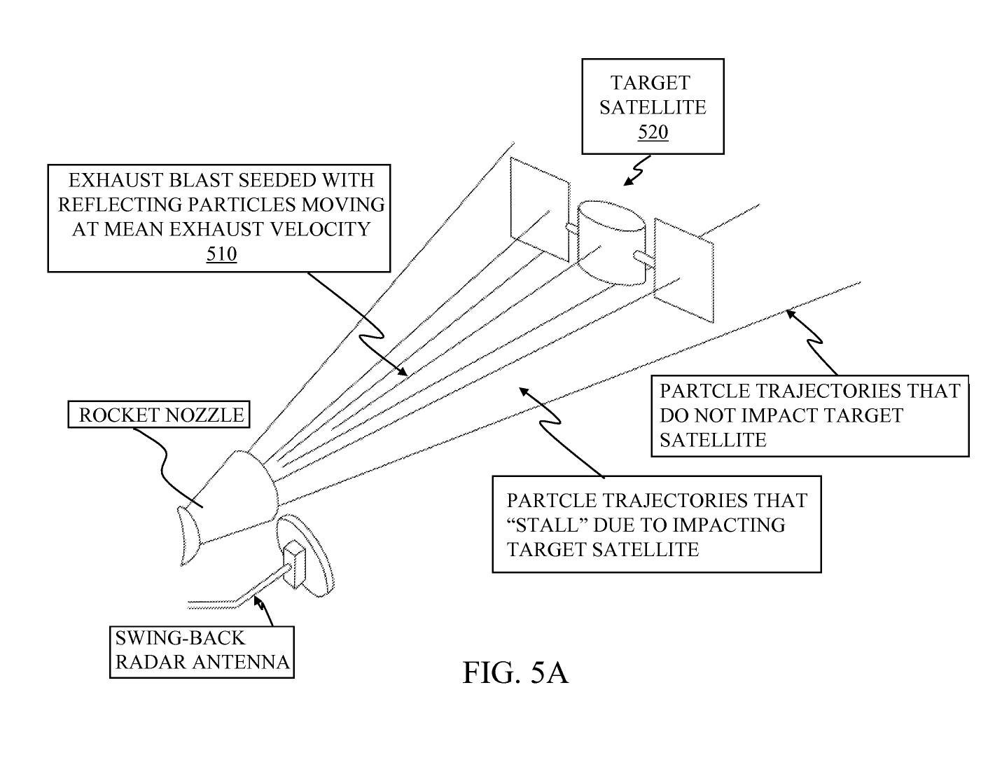

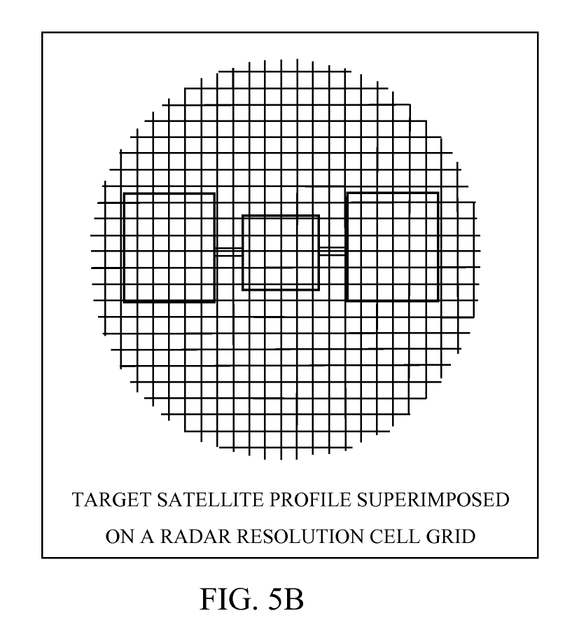

FIG. 5A shows an exemplary seeded rocket exhaust 510 impinging on a target satellite 520. FIG. 5B shows the pulse Doppler radar receiver beam, defined in this example by its half power contour, with illustrated exemplary resolution cells, centered on the satellite profile. FIG. 5B also shows the relation between an exemplary resolution cell size and the target satellite profile size and accordingly the final Doppler scatter map used for computer identification of gas-dynamic aiming points.

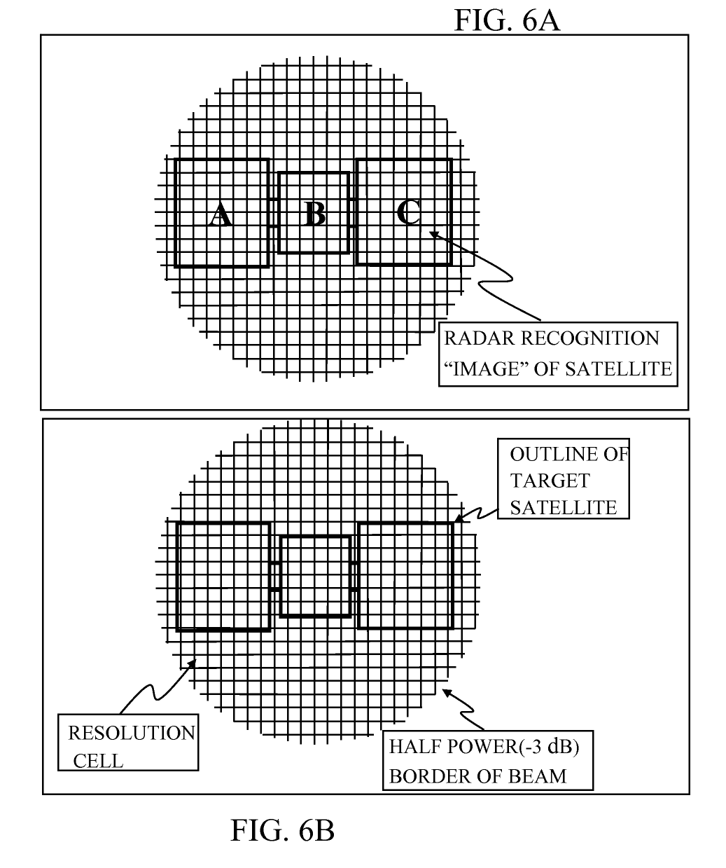

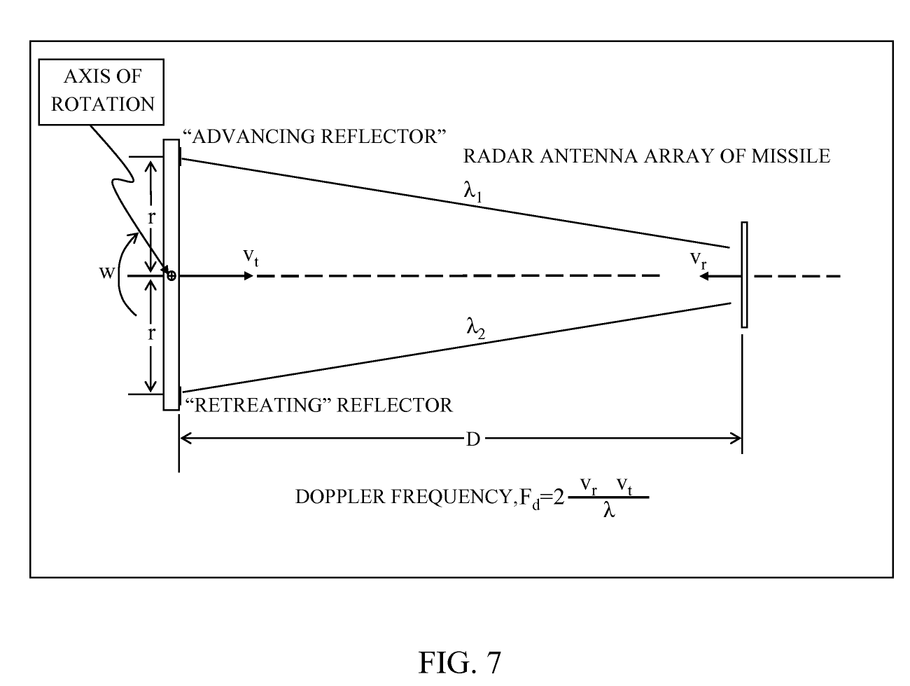

FIGS. 6A and 6B illustrate exemplary views of resolution of the target satellite image by Doppler radar. Wherein by example the profile may include B as the body of the satellite, and A and C are the solar panels. By the use of Doppler radar and comparing reflections from different portions of the target, it is possible to establish its rotation by the rate and the axis of rotation. FIG. 7 shows an idealized target satellite rotating within its axis of rotation assumed normal to the line of sight from the intercept missile to the target satellite:

The equation for Doppler frequency of radar reflecting from a target, when the target and the radar platform (missile) are moving toward each other, is:
f_{d}=2 (Vᵣ+Vₜ)/λ [Eq. 2]

Where:

f_{d}=Doppler Frequency (Hz)

Vᵣ=Velocity of Reflecting Surface Toward Radar (m/sec)

Vₜ=Velocity of Radar Toward Reflecting Surface (m/sec)

λ=Wavelength of Radar (m)

As an example, using Eq. 2, if 0.8 mm radar (upper Ka band) is employed, the short wavelength, as well as low powers, allow smaller and lighter equipment, then for a target rotation of 1 rad/sec (9.55 revolutions per minute), and reflective surfaces 4 meters apart from a mid-point axis of rotation, then the differences in reflected Doppler frequencies from the two surfaces are about 159.54 Hz. Since a satellite in circular low earth orbit (LEO) is moving at 7.906 km/sec; and assuming the intercept missile is essentially stationary, being at the top of its vertical trajectory, then the Doppler frequency of the reflected radar at the radar of the missile is 3114.5 KHz. Both of these frequencies are easily detectable with today's equipment. Table III (Appendix) lists the results of computing both approach and rotation Doppler frequencies for various basic radar frequencies. A head-on relative speed, as shown in FIG. 7, is assumed. It is assumed that the intercept missile is lofted, in direct ascent mode, to the altitude of the satellite target, but has essentially zero velocity parallel to the orbit of the satellite. Infrared imaging can supplement the radar imaging of the target satellite.

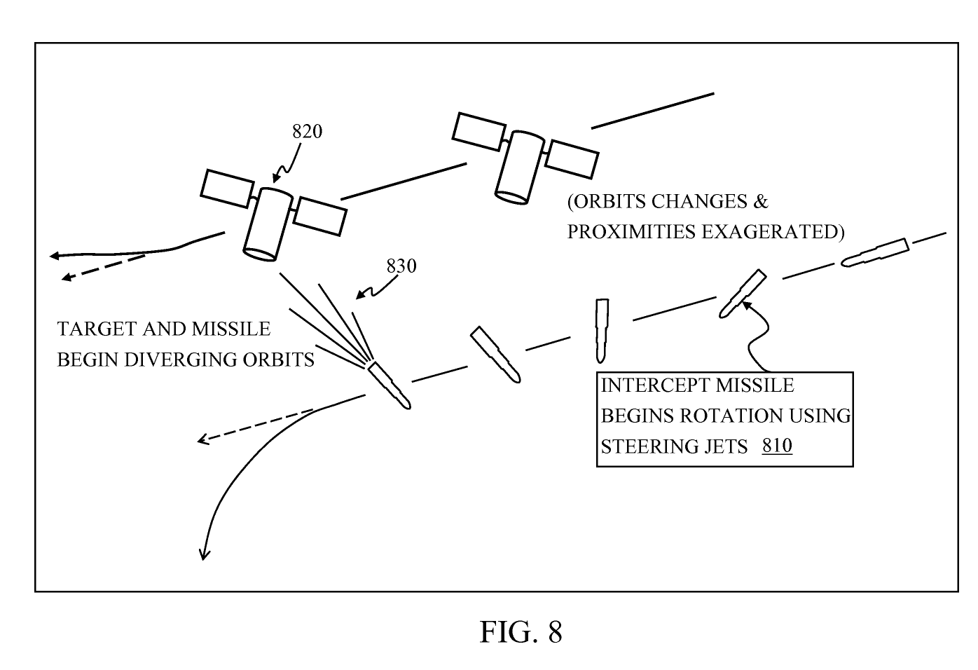

FIG. 8 shows the interceptor missile 810 orbiting in close proximity to a target 820. Its rocket exhaust blast 830 is seen imparting an impulse to the target to change its orbit.

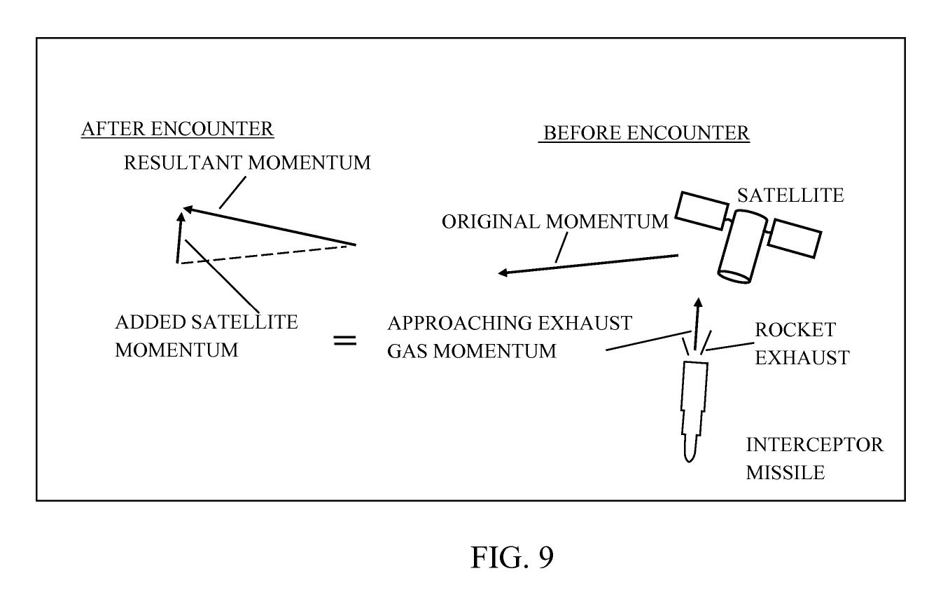

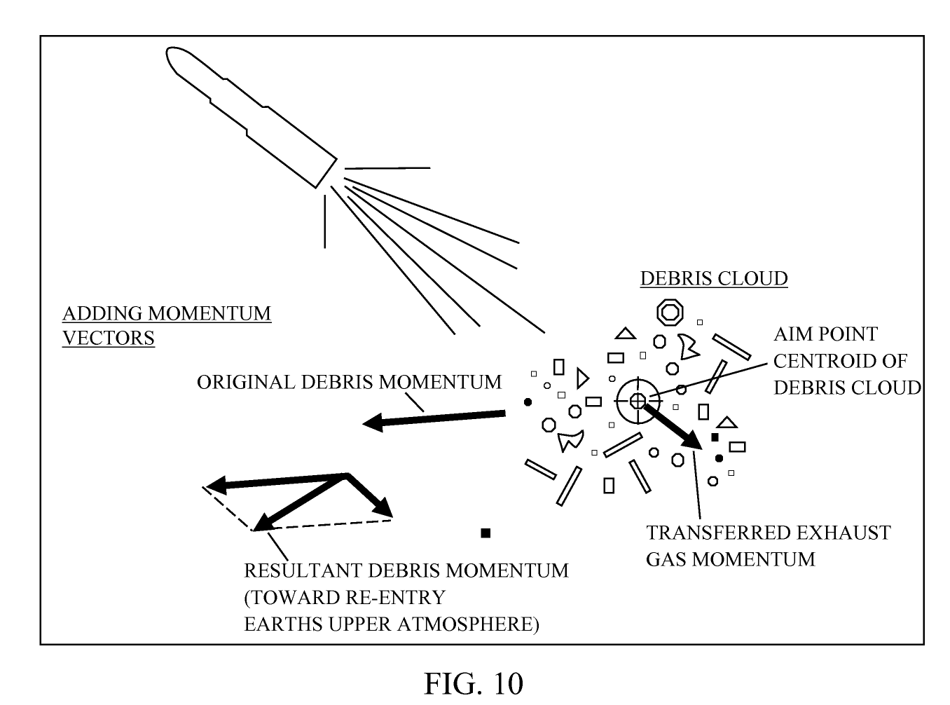

The moving blast-gas cloud may transfer momentum to any target it intercepts, as shown in FIGS. 9 and 10. The same transfer of momentum, for example, applies to the rocket exhaust version of this invention. The example of FIG. 9 shows the rescue of an expensive satellite experiencing orbital decay with eventual burn up in the atmosphere. Typically, the momentum of the rocket exhaust gas is the impulse acquired by the satellite, due to drag in the free molecule flow of the exhaust. Those molecules not striking the satellite, typically, play no role in transferring momentum. In this example, the change in the satellite momentum vector is shown exaggerated for illustration purposes; typically, it would be much less to avoid damage to the satellite. A number of encounters may be required to gently alter the orbit of the satellite. Typically, proof-of-concept testing in space, in order to evaluate various rocket exhaust values and stand-off distances, would involve an instrumented satellite, which may include accelerometers, strain gages on deformable structures, microphones for particle impact detection, and GPS, for orbit determination.

The Effectiveness of Gas-Blast Orbit Modification

To determine the effectiveness of the Gas-Blast orbit modification technique, an idealized relation between an interceptor missile and a target if parallel, or co-orbit flight is presumed. As the interceptor rocket motor fires, its exhaust plume impinges on the target and, in doing so, imparts an impulse by virtue of free-molecule drag. The result is that both the interceptor missile and the target are forced in opposite directions from a reference plane between them. While an exemplary rocket thrust may be constant, the expanding plume reduces the local particle flux density causing the dynamic pressure sensed by the target to diminish as the rocket recedes. Accordingly, a rocket motor in free space thrusting at a constant level over time, typically results in a diminishing effective thrust imparted on the target.

As shown in FIG. 10, a rocket exhaust gas-blast typically occurs at an optimum distance from the debris cloud for greater fan-out to envelop as many objects as possible. The intercept may be made at a time, location, and direction of impulse to cause the debris to enter the atmosphere at a safe location on Earth. No attempt may be made to avoid damage to the debris, as opposed to rescuing a satellite or manned vehicle.

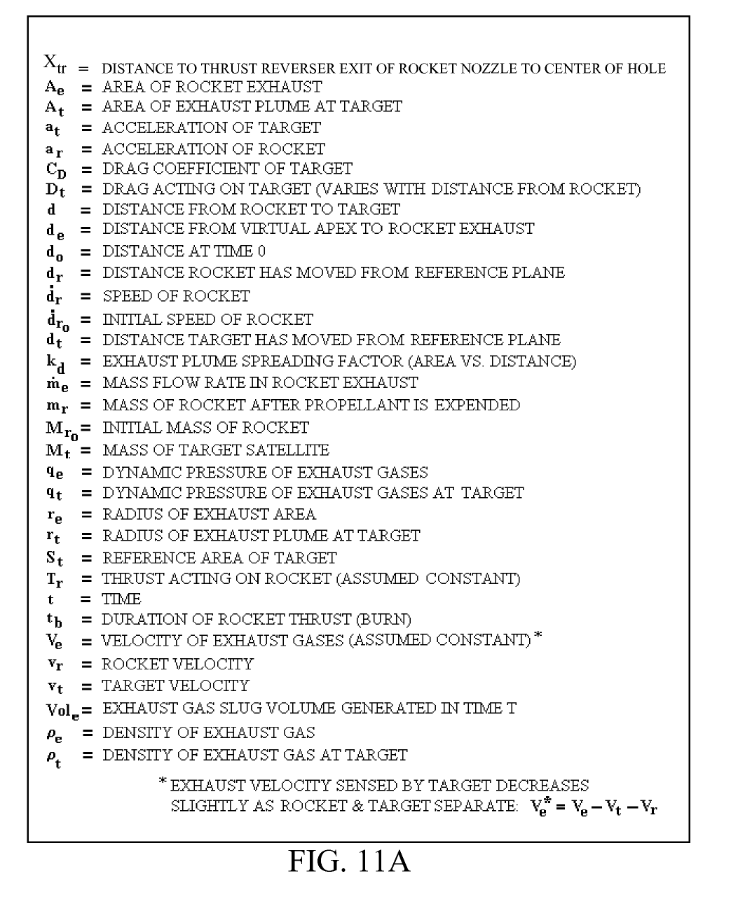

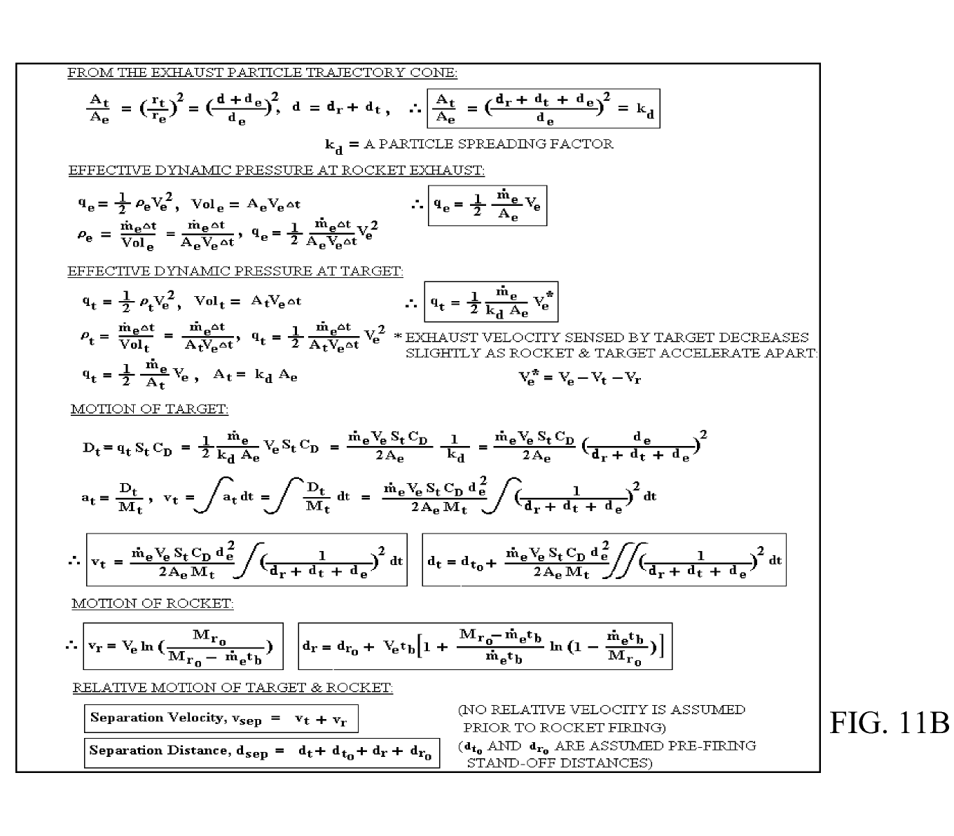

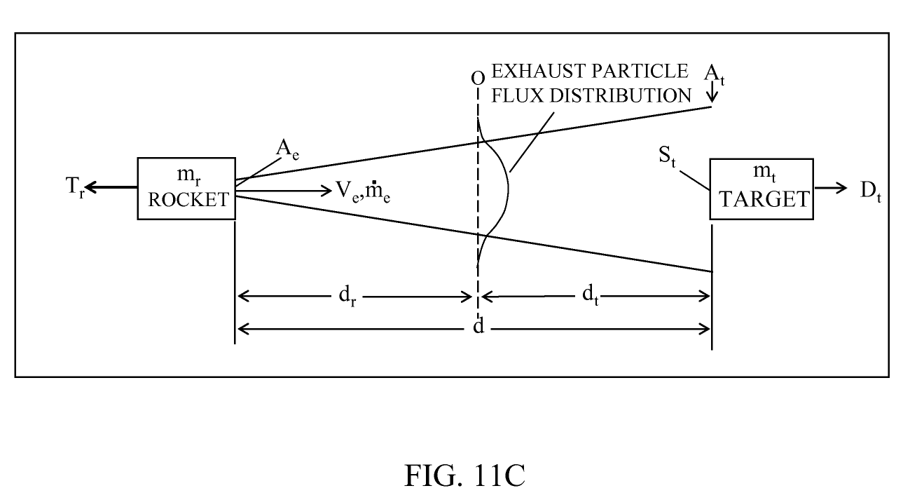

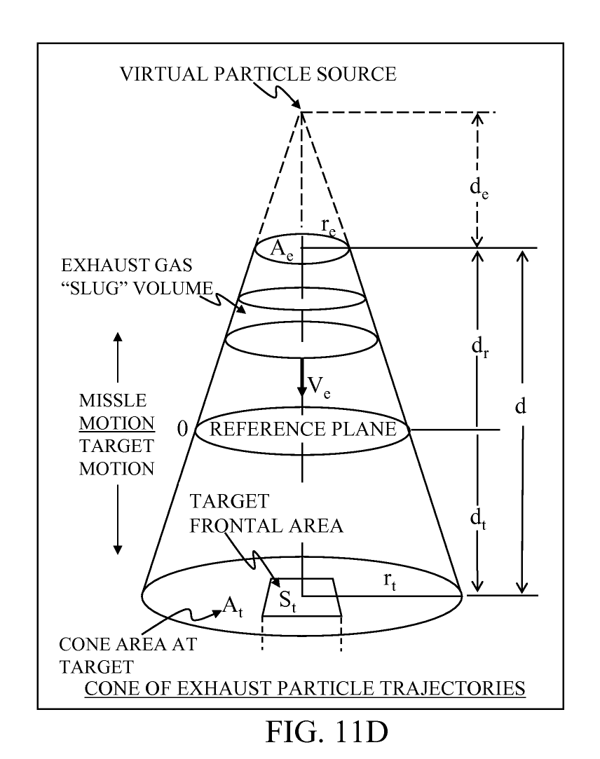

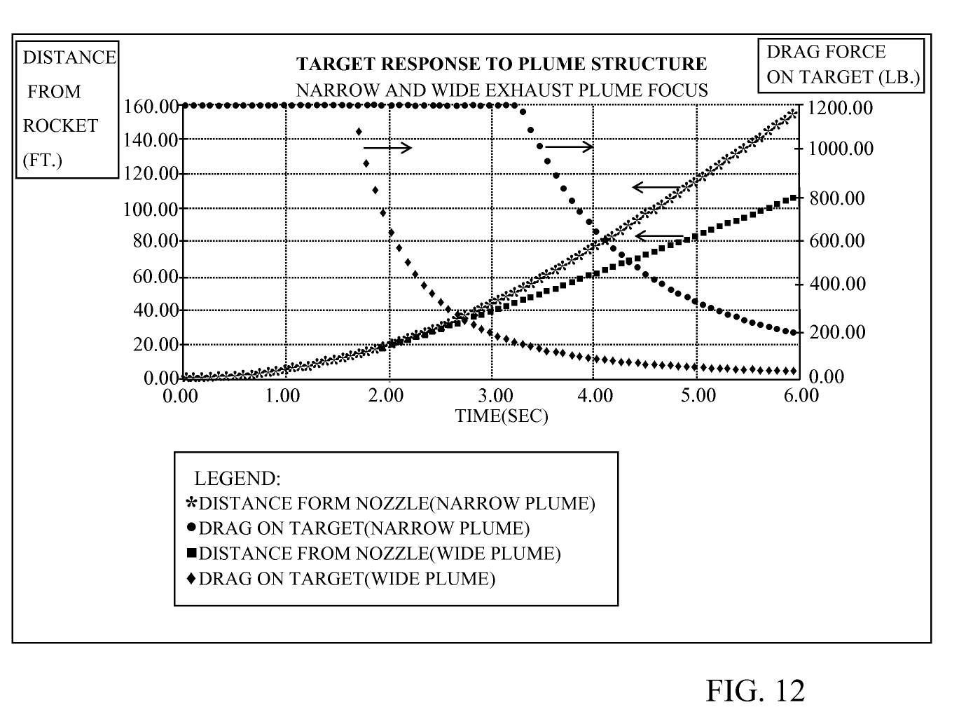

FIG. 11A shows the variables involved and the development of equations expressing the displacement of the interceptor missile and the target from a starting point between them for an idealized encounter. A simulation based on the equations of FIG. 11B, the encounter geometry of FIG. 11C and particle trajectory model of FIG. 11D may be made in order to illustrate an exemplary integrated time-history displacement of the interceptor missile and the target, the gas dynamic drag force acting on the target, its resulting velocity, and the interceptor missile propellant used. Table IV (Appendix) illustrates only one condition of no initial separation between the interceptor missile and the target and only a 50% effective thrust reverser (described below). FIG. 12 shows the resultant displacement vs. time for two exhaust geometries (narrow and wide plumes) applying the exemplary assumed conditions:

Assumed Initial Conditions

Thrust of Rocket=4000 (lb)

Exhaust Velocity=6000 (fps)

Propellant Flow Rate=21.45 (lb/sec)

Apex of Exhaust Particle Divergence Cone from exhaust (FIG. 11C):
20 ft. narrow plume, 5 ft. wide plume

Weight of Target=4000 (lb)

Reference Area of Target=40 (ft²)

Target Drag Coefficient=0.6

Area of Rocket Exhaust=3.1416 (ft²)

Thrust Reverser

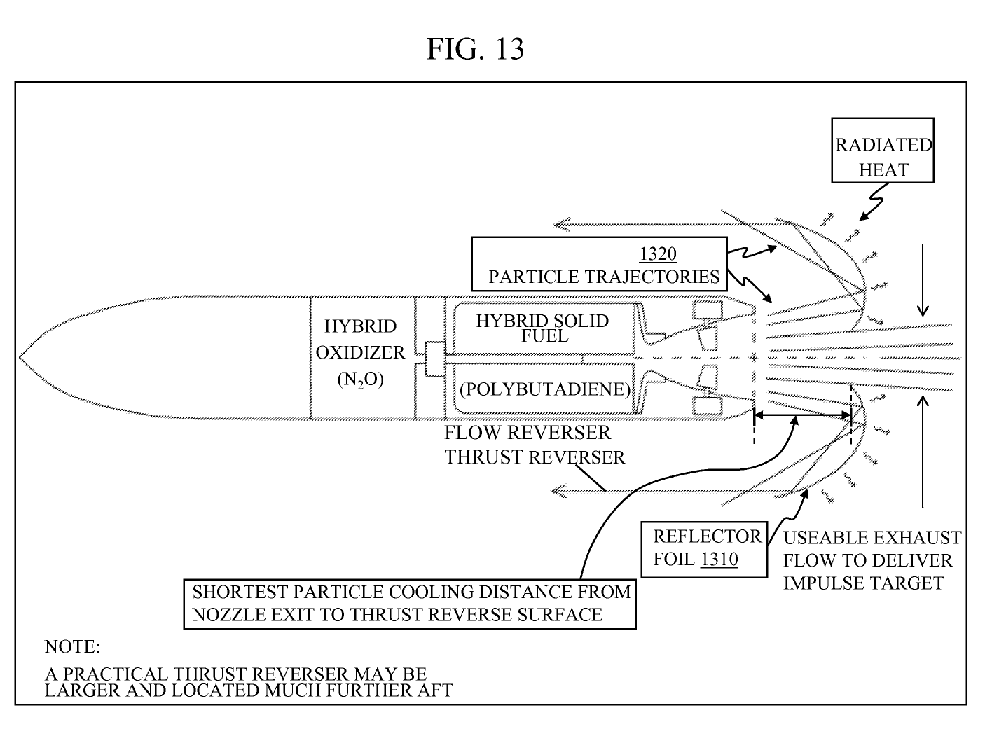

By causing a portion of the rocket exhaust blast to be deflected approximately 180 degrees from its normal direction, a reverse thrust can be imparted to the interceptor rocket to cancel in part its nominal thrust produced by the rocket motor and thereby effect a lower than nominal acceleration from the vicinity of the target object and in terms of mission time, delay the missile's departure from the area of the target object. Accordingly, the extended time within the vicinity of the target object may allow more impulse to be transferred to the target via part of the motor engine exhaust. FIG. 13 below shows an exemplary thrust-reversing reflector 1310. In this example, the thrust-reversing reflector 1310 functions similar to a mechanical filter or mask by allowing only a beam of exhaust particles to pass and the passage may be selected so that the beam provides a beam of exhaust particles sufficient to envelope the target. As shown in this example, the exhaust particles 1320 on trajectories outside the perimeter of the exemplary passage or aperture in the mask are deflected backwards by one or two rebounds from the thrust-reversing surface. Their momentum accordingly transferred to the interceptor via the connected thrust-reversing surface typically slows the departure of the interceptor relative to an interceptor without a thrust-reversing surface.

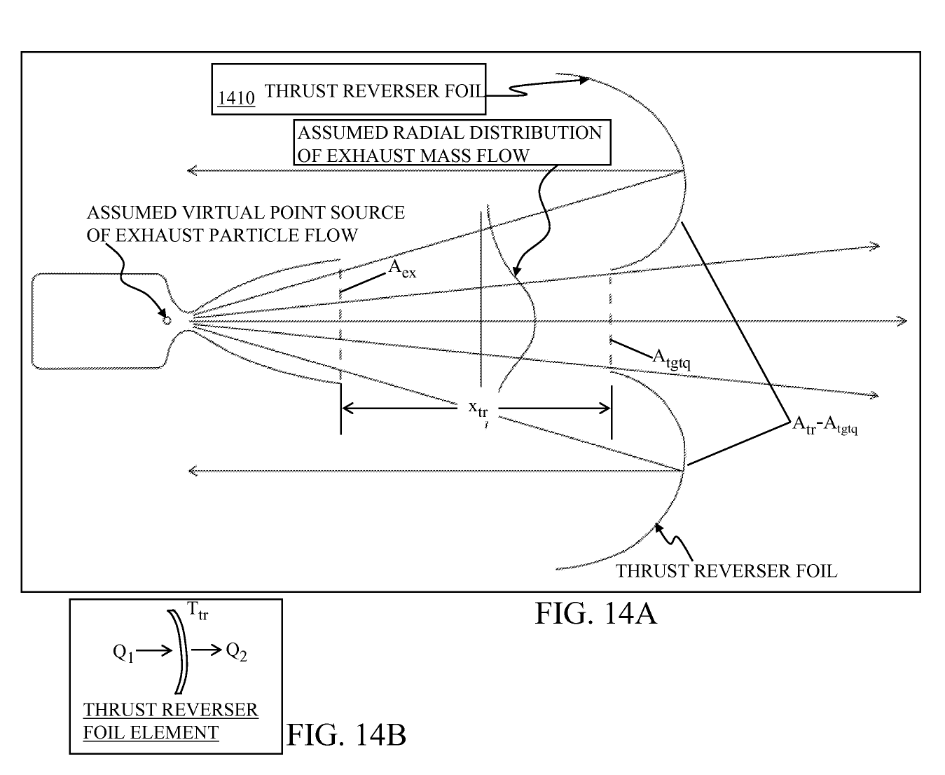

For a single particle trajectory deflection, a parabolic zone deflector 1410 is positioned relative to a focal point of an idealized conical plume of exhaust gas emanation to direct the exhaust gas molecules directly back parallel to the missile, as shown below in FIG. 14A. Different conical plume focal points may occur for different conical zones of exhaust flow. The inner zone of the deflector may direct first deflections to a second deflection from an outer zone.

The thrust reversing surface may also be termed a thrust reverser reflector which may be made of thin flexible steel foil or other metallic alloys or composites that retain structural integrity and gas particle deflecting or rebounding properties at elevated temperatures. The steel foil reflector may be deployed like a drogue chute and may be positioned and stabilized via fine steel cables. The back side, i.e., the non-deflecting or non-rebounding side of the foil may be enhanced as a heat radiating surface by being substantially coated with amorphous carbon powder.

As illustrated in FIG. 14A, the distance of the thrust reverser foil from the nozzle of the rocket motor may be selected so that an equilibrium temperature in space operation may be reached at the well below the plastic temperature of the foil. Since an exhaust plume typically increases in diameter in the direction away from the nozzle of the rocket motor, it follows that the closer the thrust reverser foil is positioned to the nozzle, the smaller the surface area of the thrust reverser.

The mass and material of the thrust reversing deflector may be functions of: (a) its size and distance from the rocket exhaust (as shown in FIG. 12); and (b) its expected heat load from the rocket exhaust. In turn, the expected heat load is a function of: (a) the cooling distance of exhaust particles; (b) the heat radiation from the back side (as shown in FIG. 14B); and (c) the heat pickup by radiation from the rocket exhaust; and heat imparted to the deflector from imperfect molecular rebound. In this example, Aₜᵣ is the total frontal area of thrust reverser, A_{tgtq} is the area of the hole in the thrust reverser for target impingement flow, ^{\dot{Q}}1 is the heat input rate to the thrust reverser foil, typically radiation and convection, ^{\dot{Q}}2 is the heat output rate from the thrust reverser foil or radiation, Tₜᵣ is the equilibrium thrust reverser foil temperature, and xₜᵣ is the distance from the exhaust nozzle to the closest thrust reverser foil. The thrust reverser may be made of steel foil in parabolic zones whose foci may be assumed to be virtual molecule source points within the rocket motor. It may be deployed and held in shape and position by steel shroud lines.

The size of the center hole or aperture of some embodiments of the thrust reverser and the outer diameter, as well as the shape, of the thrust reverser reflector typically will be a function of: the exhaust molecular beam size (expressed by half-angle) expected to envelope the target; and the desired acceleration of the intercept missile away from the vicinity of the target. This translates into the reverse-thrust load that is expected to be generated. The reflector shape may depend upon whether there are single or multiple rebounds or deflections experienced in the trajectory of an exhaust particle.

The exhaust molecular gas dynamics associated with the deflector are complex including: (a) the build-up of gas molecules at the reflector surface which may cause the flow to revert from free molecule to semi-continuum flow; and (b) the resultant boundary layer and shock waves will control the thermal convection into, or out of, the reflector surface. Changes in the direction of thermal convection may in turn alter the re-direction angle imparted to the exhaust gases, and thus the net reverse thrust. For those embodiments where the deflector is made of steel foil, its shape will both affect, and be a result of, the molecular gas dynamics.

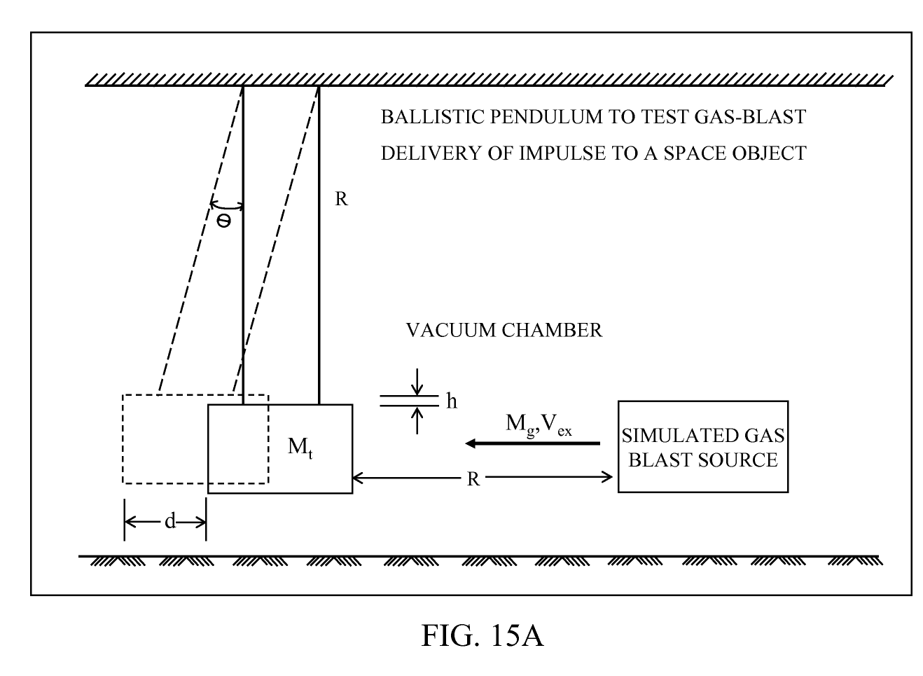

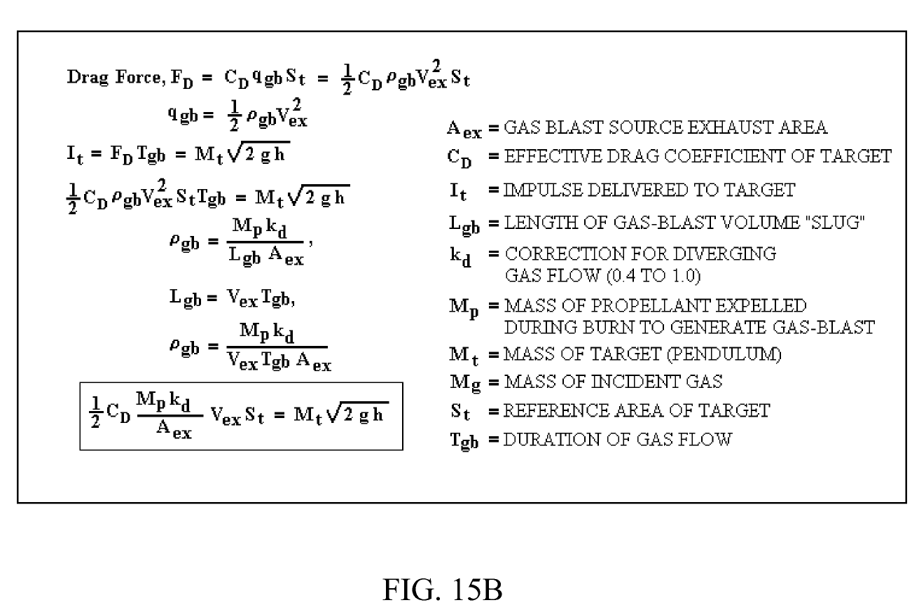

Due to the inelastic recoil of molecules from a boundary, deviation may occur from the perfect reflection assumed to describe the parabolic zones of the “thrust reverser” reflector. For explanatory purposes, an approximation is made that perfect free-molecule reflection takes place from a reflector whose shape is defined as a series of parabolic zones. In sub-scale testing: many features of the gas-blast missile's functions can be tested sub-scale in a large vacuum chamber employing a ballistic pendulum. FIGS. 15A and 15B show the principle variables involved with sub-scale ballistic pendulum examination of using a gas-blast to deliver an impulse to a space object.

The equation developed in FIG. 15B is repeated below:
½C_{D}(Mₚk_{gb}/Aₑₓ)VₑₓSₜ=Mₜ(2gh)^{1/2}=Iₜ [Eq 3]

where:

Aₑₓ=Exit Area of Rocket Nozzle

C_{D}=Drag Coefficient of Space Target

Iₜ=Delivered Gas-Blast Impulse=Acquired Momentum of Target

k_{gb}=Constant to Account for Divergence of Blast-Gas “Slug”

Mₚ=Propellant Mass Used to Generate Gas-Blast

Mₜ=Mass of Target to Receive Impulse

Sₜ=Target Reference Area

These equations relate (e.g., Eq.3) the principle variables involved and may be used to scale-down the full sized space encounter for sub-scale testing in a space chamber, where h is determined from the swing of the target pendulum in response to an incident gas-blast. It is noted that the duration of rocket motor bum, or duration of blast-gas generation, does not appear in the above equation. Thus, short, high density gas-blast slugs can be used to transfer momentum during the short time a space target and the intercept missile are in proximity. This may be done up to the limit of the structural loading that the target, such as a satellite's solar panels, can take. It is also interesting to note several dimensionless ratios in Eq.3: one is the ratio of missile propellant mass to target mass, Mₚ/Mₜ; the other is the ratio of the target aerodynamic reference area to missile rocket nozzle exit area, Sₜ/Aₑₓ.

Thermocouple and microphone instrumentation of the target pendulum may verify effects of gas-blast impingement on a target model.

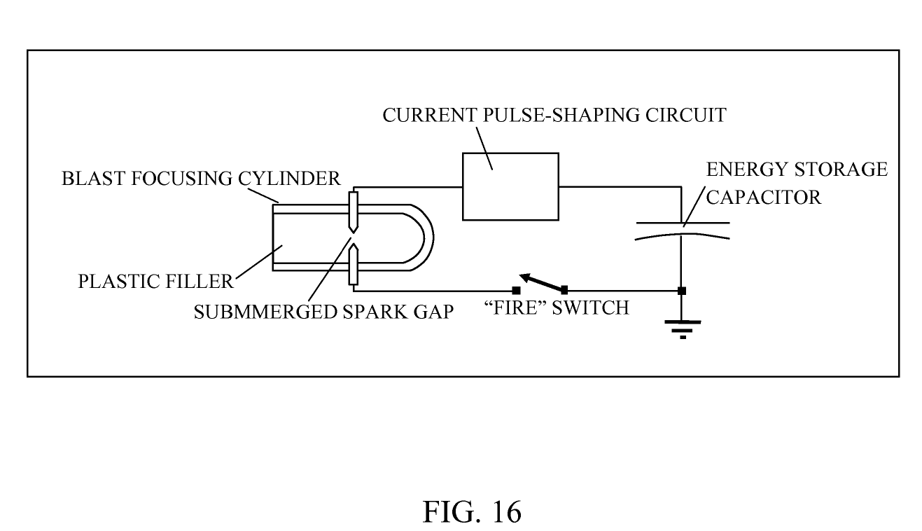

FIG. 16 illustrates an exemplary embodiment of a gas-blast generator. This example is typically better suitable for simulating a short duration pulse-type gas-blast delivery, rather than a sustained gas flow, as represented by a rocket motor exhaust.

The stored energy in the capacitor should equal a scaled fraction of the energy of the propellant, plus additional energy for circuit losses. The plastic filler typically should be frangible into minute particles and should scale to the modeled mass of propellant.

Both the rocket motor and the non-shrapnel warhead embodiments of gas-blast generators may be used in other applications where, for example, a clean blast of gas with no shrapnel is desired. One example would be in riot control wherein a blast of gas, in addition to a loud noise and flash of light, could be directed at particular individuals, without fear of harming them with shrapnel.

Another exemplary application includes focusing a gas-blast, with entrained air, at the wing or tail surface of an aircraft in flight to redirect it, for example. No damaging physical contact would be made, and a safe standoff distance for gas-blast rocket firing or warhead detonation could be determined by a computerized RF proximity system.

A very tenuous seeded gas flow aimed at any object in an industrial vacuum or in space while being observed by a pulse Doppler radar may be used for silhouette determination leading to object identification and characterization. This may be used to image various objects in space such as unknown space junk, foreign satellites of unknown purpose, or even rocks & small asteroids in near earth orbit (NEO), without the intent of applying a gas-blast impulse to them. Under certain conditions, it may be used to discriminate ICBM decoys from warheads. In this case, it may be arranged to have all such objects run into pre-deployed seeded scattering particles, for example.

An alternate gas-blast delivery system embodiment includes the non-shrapnel warhead. Prior to detonation, a frangible missile nosecone comprised of lightly fused gore sections that envelop the explosive in a low drag aerodynamic shape, e.g., that of an ogive, in order to keep low the aerodynamic drag during ascent of the missile through the Earth's atmosphere. Such a missile can be surface, air, or space launched. Space launching may provide for additional nosecone shapes. The missile may be guided to a standoff intercept point via either on-board processing with on-board sensors, off-board sensors and fire-control uplinks, or both. Depending on missile configurations, the gas blast of a directed rocket motor may be used in conjunction with a non-shrapnel warhead.

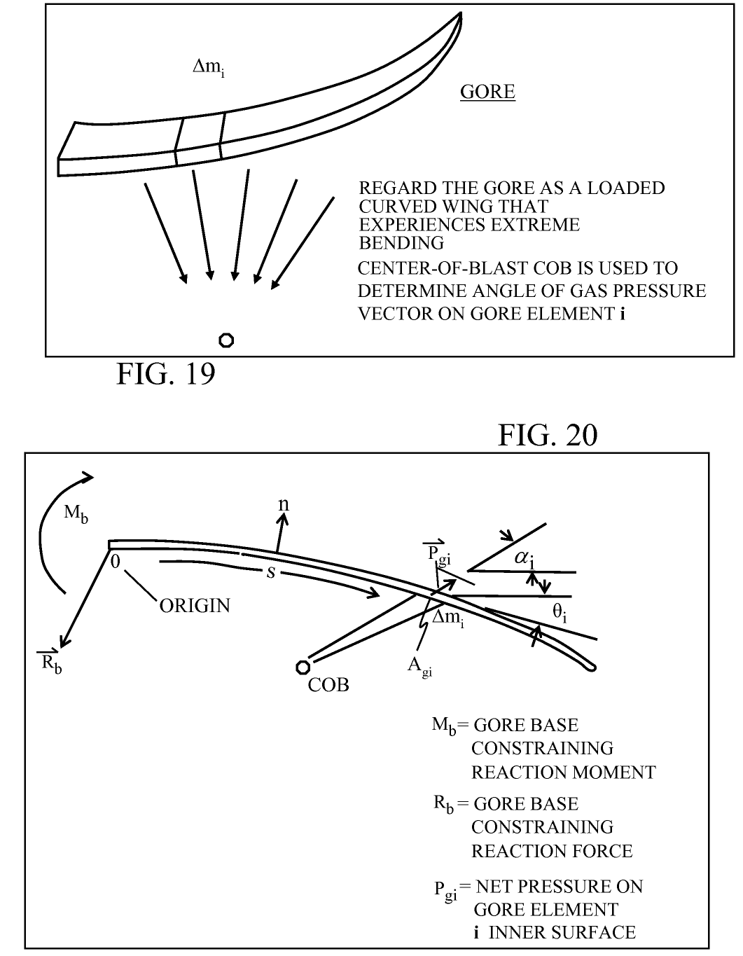

An exemplary frangible nosecone, shown in FIG. 18, is designed to tear open along pre-formed lines of weakness so that tapered gore sections (FIG. 19) are formed during the explosion. Both the stand-off detonation distance and the warhead's chemical explosive formulation are selected so that the greatest impulse is imparted to the target object, without exceeding the structural integrity of the weakest part of a valuable target (e.g., solar arrays, antennae, optical sensors, or other orbiting objects which are sought to be non-destructively changed in orbit). The warhead chemistry is designed to control the rate of gas generation and the characteristics of gas and micro-particles. The remaining missile structure after detonation may be a single mass that, apart from the remaining missile structure, adds no additional debris to space. As to the remaining missile structure, the post-detonation trajectory of the non-shrapnel warhead missile may be selected, e.g., via a retrograde impulse imparted by the detonated warhead, to cause the missile to de-orbit.

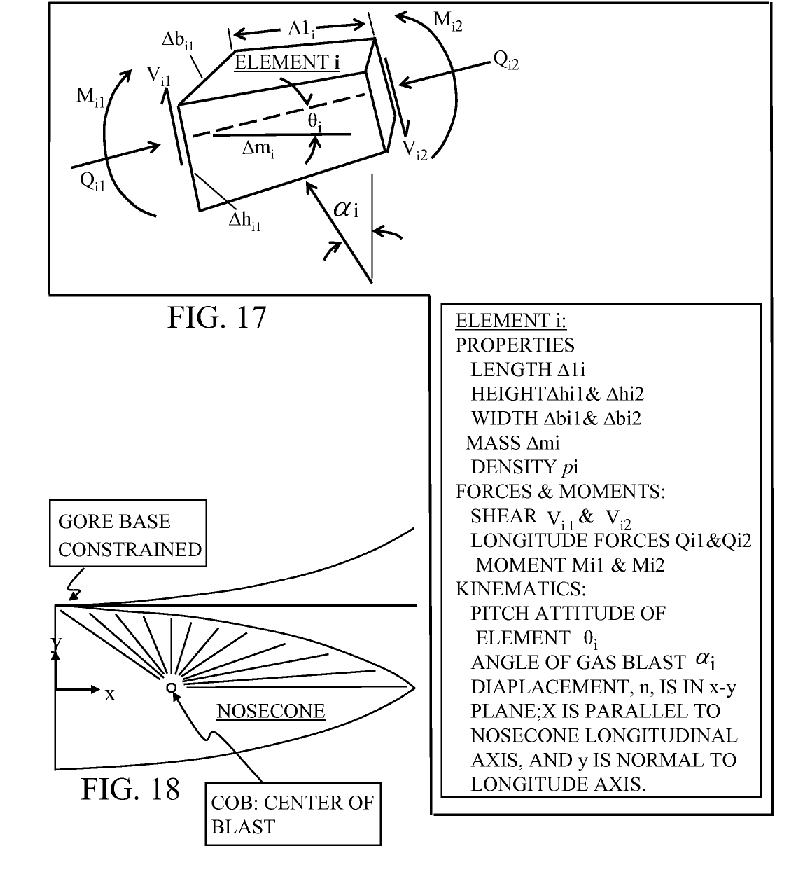

FIGS. 17-20 show the variables and presumed warhead geometry, as an example, of the non-shrapnel warhead explosion and blast-gas release. Variables shown herein are being used in a simulation of the gore shape change (FIGS. 19-20).

Although this invention has been disclosed in the context of certain embodiments and examples, it will be understood by those of ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

Appendix:

TABLE I
INTERCEPT MISSILE IMPULSE BUDGET

| Initial Conditions: | |
|---|---|
| Given Propellant Flow Rate = | 20 (lb/sec) |
| Given Specific Impulse, Isp = | 200 (sec) |
| Thrust = | 4000 (lb) |
| Total Burn Time = | 160 (sec) |
| Total Impulse = | 640,000 (lb-sec) |

| Propellant Usage: | | Propellant | Burn Time | Impulse | Missile Vel. Change |
|---|---|---|---|---|---|
| (Firing Sequence) | | (%) | (sec) | (lb-sec) | (fps) (Note A) |
| Final Intercept Trajectory | E1 | 13 | 20.1 | 83,200 | 740.3 |
| Analysis Perturbation | E2 | 3 (Note B) | 4.8 | 19,200 | 183.9 |
| Main Satellite Perturbation | E3 | 57 | 90.3 | 364,800 | 5316.6 |
| Missile De-Orbiting | E4 | 10 | 15.7 | 64,000 | 1714.9 |
| Atmospheric Deceleration | E5 | 15 | 23.5 | 96,000 | 4090.3 (Note C) |
| Missile Rotation Budget | E6 | 2 | 3.2 | 12,800 | 0.0 (Note D) |

NOTES:
A: Accounts For Progressive Loss of Missile Mass.
B: Only if a Perturbation Blast is Required to Verify Target Gas-Dynamic Center and Mass Properties.
C: When the Intercept Missile is to be saved for re-use.
D: No Missile Translational Velocities Result From Rotation Maneuvers.

TABLE II-A
EXHAUST PARTICLE TEMPERATURE-DISTANCE HISTORY
INITIAL CONDITIONS
A 2 micron Carbon Particle in Exhaust Flow Has the Following Properties:
Volume = 1.5E−16 (cu-ft), Area = 1.4E−10 (sq-ft), mass = 6.2E−16
(slugs). For an Initial Temperature of 3000 (oR), the Initial
Heat = 1.8E−11 (Btu) Particle Moves 6.1 mm in 3.4 micro-sec
at exhaust velocity of 6000 fps = .02 (ft); Particle Emissivity Assumed = 1

| | Distance | Particle |
|---|---|---|
| Time | From Exit | Temp. TC |
| (sec) | (ft) | (oR) |
| 0 | 0 | 2999 |
| .00001 | .061 | 2990 |
| .000021 | .123 | 2981 |
| .000031 | .186 | 2972 |
| .000041 | .249 | 2963 |
| .000077 | .463 | 2934 |
| .000148 | .888 | 2879 |
| .000307 | 1.84 | 2768 |
| .000691 | 4.14 | 2558 |
| .001179 | 7.07 | 2364 |
| .001757 | 10 | 2194 |
| .002925 | 20 | 1959 |
| .010517 | 63 | 1379 |
| .012852 | 77 | 1297 |
| .013436 | 80 | 1280 |
| .015188 | 90 | 1232 |
| .016356 | 98 | 1204 |
| .018703 | 112 | 1154 |
| .024005 | 144 | 1067 |
| .03 | 180 | 986 |
| .04 | 240 | 911 |
| .05 | 300 | 842 |
| .06 | 380 | 778 |
| .08 | 490 | 718 |
| .1 | 620 | 664 |
| .13 | 790 | 613 |
| .17 | 1020 | 567 |

TABLE II-B
EXHAUST PARTICLE TEMPERATURE-DISTANCE HISTORY
INITIAL CONDITIONS
A 0.2 micron Carbon Particle in Exhaust Flow Has the Following
Properties: Volume = 1.48E−19 (cu-ft), Area = 1.35E−12
(sq-ft), Mass = 6.2E−19 (slugs). For an Initial Temperature of
3000 (oR), the Initial Heat = 1.80E−14 (Btu) Particle Moves
6.1 mm in 3.4 micro-sec at exhaust velocity of 6000 (fps) Particle
Emissivity Assumed = 1

| | Distance | |
|---|---|---|
| | From | Particle |
| Time | Exit | Temp. |
| (sec) | (ft) | (oR) |
| 0 | 0 | 2991 |
| .000001 | .006 | 2982 |
| .000002 | .01 | 2976 |
| .000003 | .017 | 2967 |
| .000003 | .019 | 2964 |
| .000003 | .021 | 2961 |
| .000005 | .027 | 2953 |
| .000008 | .047 | 2926 |
| .000015 | .09 | 2871 |
| .000031 | .186 | 2761 |
| .00007 | .418 | 2551 |
| .000119 | .713 | 2357 |
| .000181 | 1.086 | 2178 |
| .00026 | 1.56 | 2013 |
| .00036 | 2.16 | 1860 |
| .006232 | 40 | 783 |
| .007261 | 43 | 745 |
| .008975 | 50 | 695 |
| .00966 | 57 | 678 |
| .010003 | 60 | 671 |
| .011717 | 70 | 637 |
| .012403 | 74 | 625 |
| .013088 | 78 | 614 |
| .014116 | 84 | 599 |
| .014802 | 90 | 589 |
| .016173 | 97 | 572 |
| .019034 | 114 | 542 |
| .024151 | 142 | 501 |

TABLE III
RADAR DOPPLER FREQUENCIES
Given Conditions:
LEO Satellite Velocity = 7.90 (km/sec); Missile Velocity = 0 (km/sec)
Translation Doppler Frequency = 5.871515 (KHz)
Major Reflecting Surfaces of Satellite are 1 and 2 m from Rotation Axis

| | | Translation | Rotation |
|---|---|---|---|
| | Reflector | Doppler | Doppler |
| Frequency | Radius | Frequency | Frequency |
| (GHz) | (m) | (KHz) | (Hz) |
| 12 | 1 | 632.4 | 160.0 |
| 18 | 1 | 948.6 | 240.0 |
| 24 | 1 | 1264.9 | 320.0 |
| 30 | 1 | 1581.1 | 400.0 |
| 36 | 1 | 1897.3 | 480.0 |
| 12 | 2 | 632.4 | 320.0 |
| 18 | 2 | 948.6 | 480.0 |
| 24 | 2 | 1264.9 | 640.0 |
| 30 | 2 | 1581.1 | 800.0 |
| 36 | 2 | 1897.3 | 960.0 |

TABLE IV
ROCKET AND TARGET DISPLACEMENT DUE TO
VARIOUS EXHAUST PLUME GEOMETRIES
Intial Wgt of Rocket = 4000 (lb) of Target = 4000 (lb)
Propellant Flow Rate = 21.44933 (lb/sec) at Veo = 6000 (fps)
Initial Mass Ratio of Rocket (Propellant Wgt./Total Wgt.) = .8
Exhaust Velocity = 6000 (ft/sec)
STAND-OFF DIST.(Dro) = 0 (ft) Plume Focus, (De) = 20 (ft)
NET MISSILE THRST = 4000 (lb)

| | Total | | | | |
|---|---|---|---|---|---|
| | Sep'n | Drag on | Acceler'n | Target | Propellant |
| Time | Distance | Target | of Target | Velocity | Used |
| (sec) | (ft) | (lb) | (ft/s/s) | (fps) | (lb) |
| 0.02 | −0.06 | 1200.00 | 9.65 | 0.19 | 0.43 |
| 0.10 | 0.23 | 1200.00 | 9.65 | 0.97 | 2.14 |
| 0.18 | 0.84 | 1200.00 | 9.65 | 1.74 | 3.86 |
| 0.26 | 1.63 | 1200.00 | 9.65 | 2.51 | 5.58 |
| 0.34 | 2.90 | 1200.00 | 9.65 | 3.28 | 7.29 |
| 0.42 | 4.43 | 1200.00 | 9.65 | 4.05 | 9.01 |
| 0.50 | 6.25 | 1200.00 | 9.65 | 4.83 | 10.72 |
| 0.58 | 8.38 | 1200.00 | 9.65 | 5.60 | 12.44 |
| 0.66 | 10.89 | 1200.00 | 9.65 | 6.37 | 14.16 |
| 0.74 | 13.73 | 1200.00 | 9.65 | 7.14 | 15.87 |
| 0.82 | 16.85 | 1200.00 | 9.65 | 7.91 | 17.59 |
| 0.90 | 20.28 | 1200.00 | 9.65 | 8.69 | 19.30 |
| 0.98 | 24.09 | 1200.00 | 9.65 | 9.46 | 21.02 |
| 1.14 | 32.55 | 1200.00 | 9.65 | 11.00 | 24.45 |
| 1.38 | 47.66 | 1200.00 | 9.65 | 13.32 | 29.60 |
| 1.54 | 59.41 | 976.38 | 7.85 | 14.75 | 33.03 |
| 1.70 | 72.33 | 721.87 | 5.81 | 15.81 | 36.46 |
| 1.86 | 86.45 | 542.72 | 4.37 | 16.60 | 39.90 |
| 2.10 | 109.82 | 364.59 | 2.93 | 17.45 | 45.04 |
| 2.34 | 135.69 | 253.29 | 2.04 | 18.03 | 50.19 |
| 2.58 | 164.04 | 181.16 | 1.46 | 18.44 | 55.34 |
| 2.82 | 194.82 | 132.89 | 1.07 | 18.73 | 60.49 |
| 3.30 | 263.56 | 76.21 | 0.61 | 19.12 | 70.78 |
| 4.02 | 384.74 | 37.38 | 0.30 | 19.43 | 86.23 |

What is claimed is:

1. A system comprising:
a rocket motor adapted to produce directed exhaust gas particles;
a targeting system adapted to determine a first aim point for the directed exhaust;
and
an attitude control system adapted to orient the rocket motor in response to the determined first aim point.

2. The system of claim 1 further comprising a thrust-reversing element adapted to deflect a portion of the directed exhaust.

3. The system of claim 2 further comprising a fuselage, the fuselage housing at least a portion of the rocket motor wherein the thrust-reversing element is a steel foil attached to the fuselage via three or more suspension lines.

4. The system of claim 1 further comprising a fuselage wherein the targeting system includes a radar system proximate to the fuselage.

5. The system of claim 4 further comprising a seeded propellant wherein the rocket motor combusts the seeded propellant to exhaust radar-reflective particles.

6. The system of claim 1 further comprising a fuselage wherein the targeting system is adapted to process radar returns from a plurality of gas particles proximate to the target space object and therefrom determine a second aim point.

7. A method of imparting momentum to a target space object comprising:
providing an exhaust gas generator proximate to the target space object wherein the exhaust gas generator is adapted to expel generated gas according to a trajectory;
directing a first blast of expelled generated gas wherein at least a portion of the trajectory of the first blast of expelled generated gas impinges on the target space object.

8. The method of claim 7 further comprising:
determining an aim point for a second blast of expelled generated gas based on radar returns from a plurality of expelled gas particles proximate to the target space object
directing a second blast of expelled generated gas wherein at least a portion of the trajectory of the second blast of expelled generated gas impinges on the target space object.

9. The method of claim 7 further comprising deflecting a portion of the expelled generated gas via a thrust reversing element.

10. The method of claim 7 further comprising deploying a thrust reversing element comprising steel foil into the trajectory of the first blast of expelled generated gas.

11. The method of claim 7 wherein the expelled generated gas of at least the first blast comprises radar-reflective particles.

12. A system comprising:
an exo-atmospheric vehicle adapted to produce a directed gas-blast via a frangible nosecone; and
a targeting system adapted to determine an aim point for the directed gas-blast;
wherein the warhead is a non-shrapnel warhead.

13. The system of claim 12 further comprising:
a rocket motor adapted to produce directed exhaust gas particles;
an attitude control system adapted to orient the rocket motor in response to a determined second aim point; and
wherein the targeting system is further adapted to determine the second aim point for the directed exhaust.
